(19) United States
(12) Patent Application Publication
(10) Pub. No.: US 2008/0185858 A1
(43) Pub. Date: Aug. 7, 2008

(54) ADJUSTABLE GAME TRANSPORTING DEVICE WITH INTERCHANGABLE GAME FASTENERS AND METHOD FOR USING THE SAME

(76) Inventor: Randy Shattuck, Greenfield Center, NY (US)

Correspondence Address: SCHMEISER, OLSEN & WATTS, 22 CENTURY HILL DRIVE, SUITE 302, LATHAM, NY, 12110, US

(21) Appl. No.: 11/670,446

(22) Filed: Feb. 2, 2007

(51) Int. Cl. B65G 7/12

(52) U.S. Cl. 294/141

(57) ABSTRACT

An adjustable game transporting device including a stick body and multiple interchangeable game fasteners is provided, wherein the interchangeable game fasteners, having the same or different configurations, which releasably attach to the stick body. The stick body has an adjustable length. A game fastener is attached to an extender that attaches to the stick body, and the stick body has receiving apertures for accepting the extender. The extender protrudes from the stick body a customizable distance corresponding to the size of the animal being secured and the distance selection of the user. The game fasteners can be released from the stick body and reattached to the stick body in the same or a different receiving aperture on the stick body allowing a user to customize the transporting device to the particular animal being secured.

### FIELD OF THE INVENTION

The present invention relates generally to an adjustable device for transporting game that allows hunters, or anyone desiring to transport a game animal, to secure a game animal so that it may be transported efficiently. Specifically, the present invention relates to a game animal transporting device that includes a stick body and adjustable/interchangeable game fasteners for securing a game animal.

### BACKGROUND OF THE INVENTION

Hunters use various configurations of animal pulls, or game dragging devices, to transport slain game animals from the field. Typical animal pulls include a rope neck harness, hooks, or straps that secure the animal. Others have a cart having a frame that is large and bulky. Similarly, devices known as gambrels are designed to hold a game animal so that it may be hung in a suspended position. Commonly, animal pulls are limited to one configuration for securing the game animal, regardless of whether the animal has antlers, is large game or small game, or whether there is more than one animal being secured. Therefore, a user has little flexibility in how the game will be secured.

Accordingly, there is a need for an improved game transporting device that allows a user to customize the device configuration to best facilitate the transport of game.

### SUMMARY OF THE INVENTION

The principal object of this invention is to provide an adjustable game transporting device having interchangeable game fasteners of various configurations that allow a user to easily customize the game transporting device in the field to the particular game animal or animals being secured for more efficient transport of the game animal out of the field. A hunter's objective is to kill a game animal of his choice. Once the animal is down, the hunter is faced with transporting it from the field back to camp or the roadside. Transport of game such as deer, elk, oxen, bear, or the like can be over rough terrain and in cold weather. Normally, a deer can weigh up to 150 pounds and bear, elk, or moose can weigh even more. Moreover, the camp or road is often a long distance away from the location where the animal lays. Dragging the kill is awkward and hard work. Thus, it is desirable to have an easy to carry tool that offers an efficient and safe way to get the kill out of the woods.

A hunter will commonly carry some sort of mechanism into the field so that he will be able to pull his kill back to camp or his vehicle. He may carry an animal pull, sometimes a deer drag, or he may fashion his own drag system out in the woods. When the game animal has antlers, such as a male deer, or buck, it is desirable to use the antlers to pull the animal. If the animal does not have antlers, the hunter may choose to secure the animal by its neck and/or front legs. If the hunter carries an animal pull, he is limited to the securing configuration provided by that device regardless of the size or type of animal.

Furthermore, pulling the animal over ground that may be uneven or have obstacles that interfere often requires the hunter to have to stop and readjust the animal pull or drag lines or other game fastening components. If the drag system is not adjustable to tightly secure the animal, the hunter will need to stop more frequently to adjust the ropes that may have become loose or to rest his hands that have become cut or sore because the handle he is using is not smooth or the rope is cutting into his skin. For the foregoing reasons, it is desirable to have a compact, easy to carry, adjustable game transporting device having interchangeable game fasteners that allow the user to customize the device to the particular animal being secured.

The transporting device of the present invention is lightweight, compact, and easily adjustable to fit the particular game that may be secured. Interchangeable game fasteners allow the user to choose the most effective fastening device for the particular animal being transported. For example, game that has antlers may be transported via an antler clasp attachment that secures the antler and does not need to be readjusted during transport. Likewise, antlerless game may be secured using a neck harness that adjusts to fit the particular animal that will be transported. Both securing systems allow the game animal to be secured without piercing the body of the animal. In addition, the device allows more than one animal to be secured for pulling multiple animals at the same time.

The transporting device allows for further customization to the size of the particular animal or animals being transported. The game transporting device of the present invention may include a stick body and adjustable game fasteners. The stick body may have an adjustable length that may be customized in the field to fit the size of the game animal being secured. Extenders may help secure the game fasteners to the stick body and may also have an adjustable length. In addition, the extenders may include a swivel head that may attach to the game fastener giving the fastener flexibility so that it may be attached more securely to the animal. The game fasteners may also be adjustable to the size of the animal being secured. Furthermore, there may be several possible configurations of game fasteners and one or more may be used at the same time. For example, there may be an antler clasp game fastener, which may work for game having antlers, a neck harness game fastener for those not having antlers, and a small game fastener. These fasteners may be interchangeable and adjustable such that a hunter can choose the best means for securing his kill for an efficient transport out of the field.

A first general aspect of the present invention provides an adjustable game transporting device comprising: a stick body; at least one releasable extender having a first end and a second end, wherein the first end is adjustably attached to said stick body such that the extender protrudes from said stick body a modifiable distance; and at least one game fastener, wherein said game fastener is adjustable to secure the game animal, and wherein said game fastener is operatively attached to the second end of the releasable extender.

A second general aspect of the present invention provides a game transporting device comprising: a stick body; at least two handles attached to said stick body; and a plurality of interchangeable game fasteners, wherein said plurality of interchangeable game fasteners are configured to removably attach to said stick body, wherein a first game fastener of said plurality of game fasteners is of a first configuration and a second game fastener of said game fasteners is of a second configuration, and wherein at least one of said plurality of game fasteners is attached to said stick body.

A third general aspect of the present invention provides a device for transporting game comprising: a handle; at least two interchangeable game fasteners, wherein a first of said plurality of game fasteners is of a first configuration and a second of said game fasteners is of a second configuration; at least one game fastener extender configured to releasably attach to the interchangeable game fasteners, wherein said extender includes a game fastener end and a connecting end, and wherein said extender further includes means for removably securing said connecting end of the game fastener extender to the handle.

A fourth general aspect of the present invention provides a method of transporting game comprising: providing a bar having an adjustable length and at least two handles on opposing ends of the bar; providing an extender configured to be removably secured to the bar such that the extender extends from the bar by a length that is customizable to fit a game animal; providing a plurality of interchangeable game fasteners that may be attached to the extender; fastening the game animal to at least one of the plurality of game fasteners; connecting the extender to the bar; and pulling the bar to thereby drag the game animal.

### BRIEF DESCRIPTION OF DRAWINGS

Some of the embodiments of this invention will be described in detail, with reference to the following figures, wherein like designations denote like members, wherein:

FIG. 1 depicts a top view of an embodiment of a game transporting device including an antler clasp game fastener;

FIG. 2 depicts a top view of an embodiment of a game transporting device including a game securing harness game fastener;

FIG. 3 depicts a perspective view of an embodiment of a game transporting device including a hunter's harness;

FIG. 4 depicts top view of an embodiment of a game transporting device insertable within in a carrying sack. including an antler clasp game fastener, a game securing harness game fastener, and a side view of a carrying sack for enclosing the game transporting device and attachments; and

FIG. 5 depicts a side view of an embodiment of a game transporting device attached to a game animal.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. Although the drawings are intended to illustrate the present invention, the drawings are not necessarily drawn to scale.

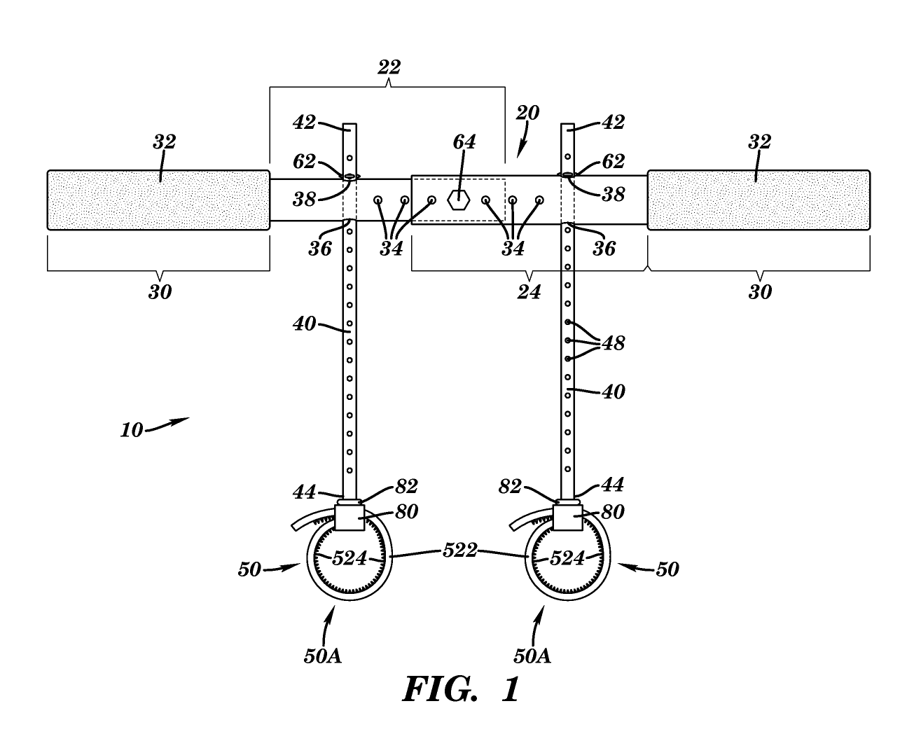

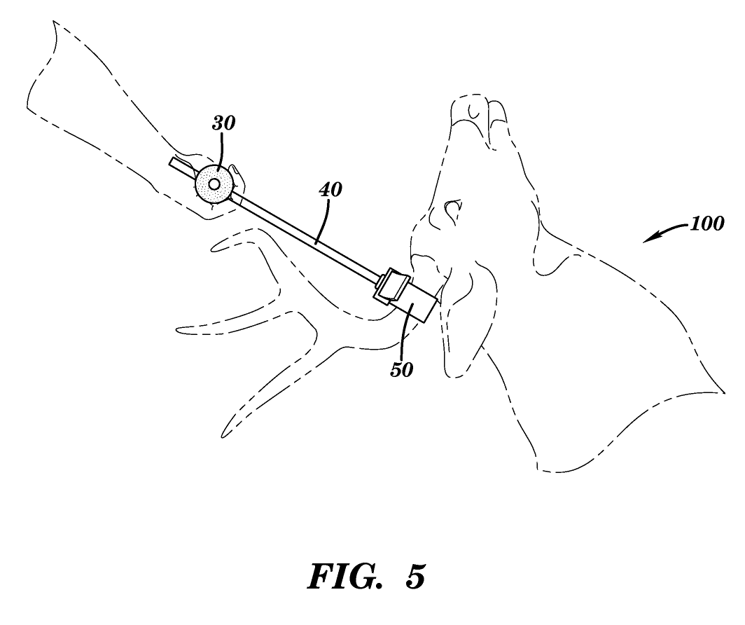

FIG. 1 shows a first embodiment of an adjustable game transporting device 10 of the present invention. The adjustable game transporting device 10 may be used for transporting game 100 (FIG. 5) from the site of the kill, oftentimes in the woods and possibly a long distance from a road or camp. The game transporting device 10 may be used for securing the game 100 so that it does not become loose during transport and for providing a tool that is easy to carry, grip, and use to pull a slain game animal out of the woods. The game transporting device 10 may include a stick body 20 and interchangeable game fasteners 50. The game fasteners may be attached to the stick body 20 by a releasable extender 40. Various features of the present invention are described further herein as follows.

The game transporting device 10 may include a stick body 20. The stick body 20 may be constructed of metal, plastic, thermoplastic, wood, or any material that is rigid enough to withstand the force generated by pulling an animal weighing up to 200 pounds. The stick body 20 may be a hollow cylindrical baton or bar having an adjustable length or may include a first section 22 and a second section 24. The second section 24 may be hollow and the first section 22 may be of solid construction or the sections 22/24 may be structurally and functionally configured vice versa wherein the first section 22 may be solid and the second section 24 may be hollow. Moreover, both the first section 22 and the second section 24 may be hollow, wherein one of the first or second sections 22 and 24 may have a larger tube-like diameter than the other. The stick body 20 length may be extendable to any length. For example, an embodiment of the stick body 20 may be approximately two feet or any length that will allow a person to comfortably grip the stick body 20 while it is behind the person's back. The stick body 20 may be collapsible so that it has a shorter length, for example, to approximately half of the length of the extended stick body 20 length for carrying and storage, or to a length that corresponds to the size of the game animal 100 being secured. For example, if the game animal 100 is a large buck, the stick body 20 may be used in the fully extended position. However, if the game animal 100 is a rabbit, the stick body 20 may be collapsed to a smaller size. The stick body 20 may be collapsed to the most compact position for storage and transport.

As shown in FIG. 1, an embodiment where the length of the stick body 20 is collapsible may include a first section 22 that may slide into a second section 24. The first section 22 may slide out of the second section 24 and be secured by a retainer pin 64 to keep the stick body 20 in the selected position. The first section 22 and second section 24 may have apertures 34 aligned longitudinally along the stick body 20 length that may be aligned to allow the stick body 20 length to be customized to the size of the game being secured.

In one embodiment, the apertures may be positioned longitudinally in the center of the stick body length for approximately 16 inches and be spaced approximately one to two inches apart. The first section 22 of the stick body 20 may have a plurality of apertures 34 and the second section 24 of the stick body 20 may have at least one aperture 34. The first section 22 may slide inside the second section 24 and at least one aperture from the plurality of apertures of the first section 22 may be aligned with the at least one aperture 34 on the second section 24. A retainer pin 64 may be configured to fit through the apertures 34 and may be inserted through the aligned apertures 34 in the first section 22 and the second section 24 to connect the first section 22 to the second section 24 and lock the amount that the stick body 20 is extended.

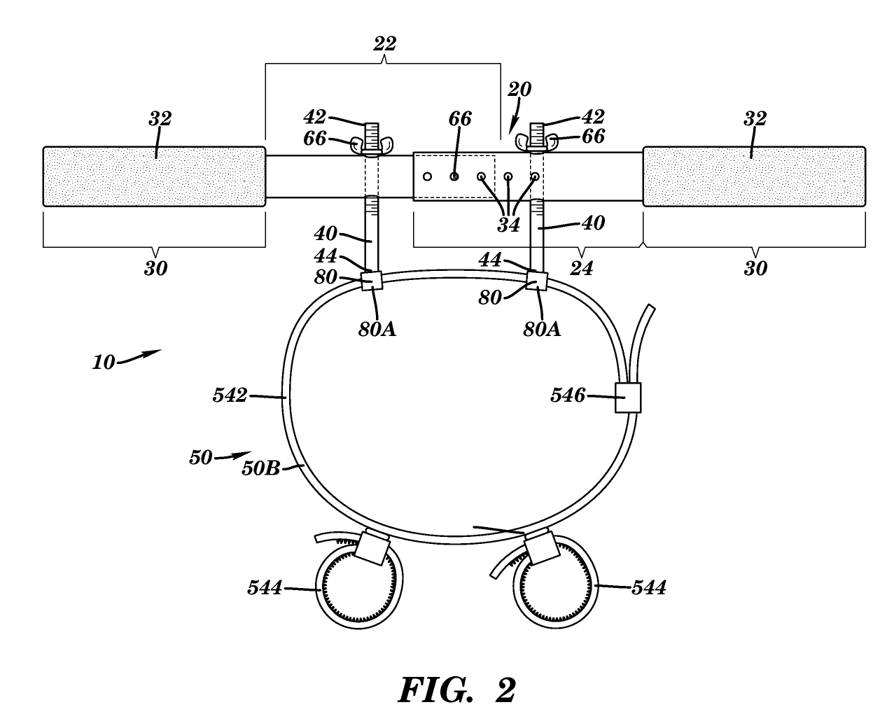

Alternatively, as shown in FIG. 2, the second section 24 may have a plurality of apertures 34 arranged in a longitudinal series and the first section 22 may be configured to slide inside the second section 24. A spring-loaded pin 66 may be affixed to the first section 22. The spring-loaded pin 66 may be operably positionable within an aperture 34 of the second section 24 so as to stabilize the first section 22 and the second section 24.

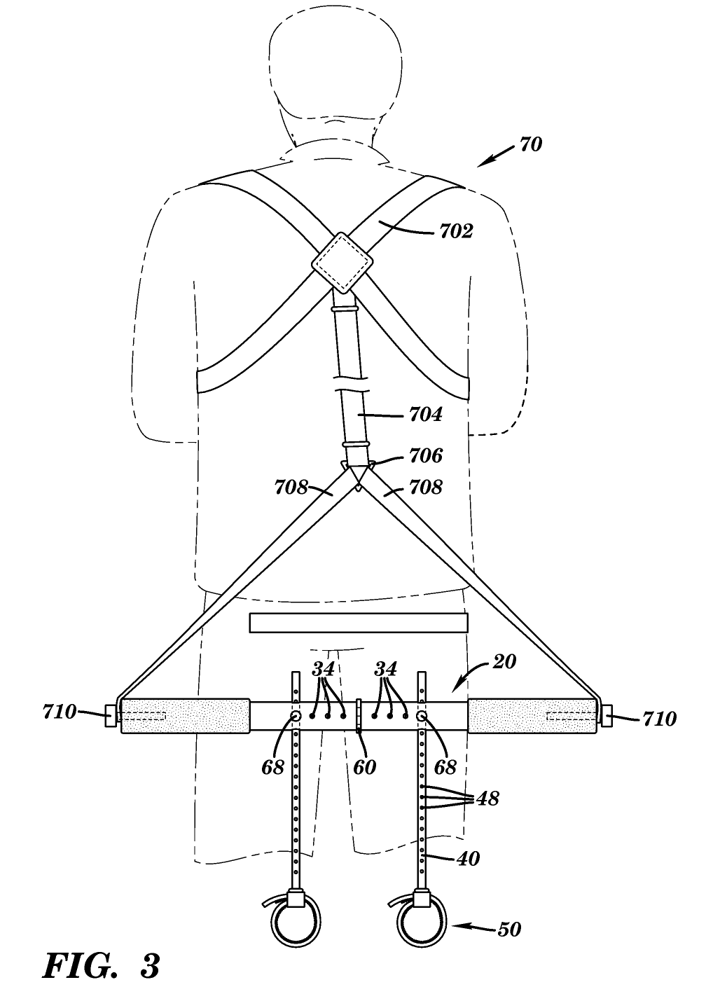

FIG. 3 illustrates that the stick body 20 may include a hinge 60 so that the first section 22 and the second section 24 may fold into a size that is smaller for transport and storage. In other words, the first section 22 of the stick body 20 may be pivotally connected to the second section of the stick body 24.

The stick body 20 may be telescoping so that it collapses into a smaller size for transport and storage but extends to adjustable lengths for use. Again, the length of the stick body 20 may correspond to the size of the game animal 100 being transported.

The stick body 20 may be a bar configured to include at least one handle 30 and grip 32. The stick body itself may be the handle 30. Alternatively, there may be two handles 30 attached to the stick body 20. As shown in FIG. 2, the handles 30 may be on opposing ends of the stick body 20, which would allow either one person to grip the device using two hands, or two people to grip the device with one hand. The grip 32 may have surface features configured to enhance gripping. For example the grip 32 may be a no slip rubber material that extends the length of the stick body 20. The grip 32 may be created by grooves, ridges, channels, or contours on the handle 30.

The stick body 20 may be configured to receive at least one extender 40 and may be configured to receive more than one extender 40. For example, the stick body 20 may include at least one receiving aperture 36 and corresponding exit aperture 38 located diametrically opposite of the corresponding receiving aperture 36 so that a rod having a diameter that is smaller than the receiving aperture 36 and the exit aperture 38 may be inserted into the stick body 20 through a receiving aperture 36 and exit aperture 38 pair. One or more receiving aperture 36 and exit aperture 38 pair may be located perpendicularly to the longitudinally aligned apertures 34 of the stick body 20. Alternatively, the stick body 20 may include a receiving aperture 36 that is located perpendicularly to the longitudinally aligned apertures 34, and not include an exit aperture 38. For example, the receiving aperture 36 may extend all the way through a solid stick body 20, or only extend through a portion of a solid stick body 20.

The adjustable game transporting device 10 of the present invention may include a releasable extender 40 having a first end 42 and a second end 44. The first end 42 may be a connecting end that may be adjustably attached to the stick body 20. The second end 44 may be a game fastener end that may attach to a game fastener 50. The extender 40 may be a metal peg or rod, or any element that is configured to positionally maintain the game fastener an adjustable distance from the stick body 20 so that the game 100 is not directly up against the stick body 20 or too close to the stick body 20 such that it interferes with the transport process. The extenders 40 may keep the game 100 from being too close to the hunter's back while he is dragging the game 100 out of the woods.

The extender 40 may have a diameter or cross section that fits through the receiving aperture 34 of the stick body 20. Moreover, the present invention may include any configuration that allows the extender 40 to protrude from the stick body 20 a modifiable distance and allows the extender 40 to be releasably secured. For example, the extender 40 may have a plurality of longitudinally aligned holes 48 along the length of the extender 40 that may provide adjustability to the extender 40. The extender 40 may be inserted into the receiving aperture 36 of the stick body 20 an amount that allows the extender 40 to protrude from the stick body 20 a distance that may correspond to the size of the game animal 100 being secured or an amount selected by the user. Furthermore, any means for securing the extender 40 to the stick body 20, such as a cotter pin 62 (see FIG. 1), nut and bolt, wingnut 66 and bolt (see FIG. 2), holding pin 68 that keeps the extender 40 from detaching from the stick body 20 (see FIG. 3), nail, screw, a spring loaded pin that fits into an aperture 34 on the stick body 20, or any other retaining device that may be inserted into the hole 48 of the extender 40, may be employed to secure the extender 40 to the stick body 20.

In a first embodiment of an extender 40, shown in FIG. 1, a retaining device may be inserted into a hole 48 of choice in the portion of the extender 40 that is protruding from the exit aperture 38 of the stick body 20. For example, once the extender 40 is inserted through the receiving aperture 36 and the corresponding exit aperture 38 in the stick body 20, a cotter pin 62 may be inserted in a hole 48 that is adjacent to the exit aperture 38 so that the extender 40 is secured to the stick body 20 in the desired position. The device may be customizable to the size of the game being secured because the cotter pin 62 may be inserted in any one of the holes 48 in the extender 40, thus allowing the extender 40 to protrude from the stick body 20 a modifiable distance depending on the size of the animal 100.

FIG. 2 illustrates a second embodiment of an extender 40, where the extender 40 may function without holes. For example, the extender 40 may have threads on the first end 42, which may be an end that may connects to the stick body 20. Moreover, a wingnut 66 or nut may also be used to secure the extender 40 to the stick body 20. The wingnut 66 or nut may be adjusted a modifiable distance from the stick body 20 so that the extender 40 may extend a selected distance from the stick body 20 depending on the size of the game animal 100 being secured.

A third embodiment of an extender 40, shown in FIG. 3, may utilize the longitudinally aligned apertures 34 in the stick body 20 and a hole 48 in the extender 40 that may be alignable with one or more of the longitudinally aligned apertures 34 in the stick body 20. Thus, the extender 40 may be inserted through a receiving aperture 36 in the stick body 20 such that one of the holes 48 in the extender 40 may be aligned with one of the longitudinally aligned apertures 34 in the stick body 20. A retainer pin 68 configured to fit through an aperture 34 of the stick body 20 and a hole 48 of the extender 40 may be inserted through the longitudinally aligned aperture 34 of the stick body 20 and the hole 48 of the extender 40 to secure the extender 40 to the stick body 20. The user may select a distance that the extender 40 may be inserted into the stick body 20 to secure the extender 40 at a preferred position. As such, the extender 40 may protrude from the stick body 20 a customizable distance corresponding to the size of the game animal 100 and distance selection of the user.

Furthermore, the releasable extender 40 may include a connector 80 (see FIG. 2) at the second end 44 that secures a game fastener 50 to the extender 40. The connector 80 may be attached directly to the second end 44 of the extender 40. The connector 80 may allow permanent attachment of the game fastener 50 or provide releasablity. The connector 80 may be any device which may attach the game fastener 50 to the extender 40, such as a snap, clip, strap, hook, hook and eye fastener, hook and loop fastener, tie, and buckle, etc. The connector 80 may be a band 84 having any connecting device that secures the game fastener to the extender 40. The band may be constructed of leather, fabric, plastic, rubber, or metal. The band 84 may be sewn in place, have a rivet, snap, button, hook and loop fastener, buckle, D-ring, tie, clip, toggle, or any device that secures the band 84 around the game fastener 50. Alternatively, the connector 80 may be a receiving connector that accepts a complementary connector attached to the game fastener 50. For example, the connector 80 may be clip having either the male or female portion on the extender 40 and the complementary portion on the game fastener 50.

The connector 80 may include a swivel head 82 (see FIG. 1) or any device that allows the game fastener 50 to have a flexible position that may be rotated thereby allowing the game animal 100 to be easily and tightly secured. The swivel head 82 may operatively connect the extender 40 to the game fastener 50.

The adjustable game transporting device 10 of the present invention may further include at least one game fastener 50 that may be adjustable to secure a game animal 100. FIG. 1 illustrates that there may be one extender 40 per game fastener and more than one extender and fastener pair, while FIG. 2 shows that there may be two extenders 40 per game fastener 50. Embodiments of the game fastener 50 may be operatively attached to the second end 44 of at least one extender 40 or may have one or more extenders integral to the game fastener 50. Alternatively, the game fastener may be releasably attached to the second end 44 of the extender 40 via a connector 80. Furthermore, the game fastener 50 may attach to a swivel head 82 located at the second end 44 of the extender 40.

As shown in FIG. 1, a first configuration of game fastener 50 may comprise an antler clasp 50a that may be adjusted to fit any size of animal's antlers to which the antler clasp 50a is attached. The antler clasp 50a may include straps 522 that may secure the antlers of a game animal 100. The straps 522 may be constructed of one or more materials selected from the group consisting of leather, rubber, microfiber, plastic, nylon, metal, fabric, chain, rope, other like materials and/or any material that would allow a user to secure that antlers of a game animal 100, or any combination of the foregoing materials. In one embodiment, the strap 522 may be formed of rubber and may be configured with ridges 524 that may operate to hold the strap 522 in place when pulled by a user around an antler. The straps may be fed through a clip having a stop tooth or any securing device that may hold the rubber strap in place. The clip may be opened to release the cinch strap 522.

As shown in FIG. 2, another embodiment of a game fastener 50 may be a game securing harness 50b that may include a collar strap 542 for securing the neck of a game animal 100. The collar strap 542 may be constructed of rubber, fabric, chain, leather, rope, any material that allows a user to secure a game animal 100 around the neck, or any combination of the foregoing materials. The collar strap 542 may be adjustable to the size of the game animal 100 and may include a clasp 546 that may allow the user to open the collar strap 542 to secure or release the game animal 100. A first configuration of collar strap may be configured to fit large game animals and a second configuration of collar strap may be configured to fit small game animals.

Further, the game harness 50b may include at least one ankle cuff 544 that may be releasably or permanently attached to the collar strap 542. The at least one ankle cuff 544 may be configured to secure the feet, legs, or ankles of the game animal. If one ankle cuff 544 is attached to the collar strap 542, it may be used to secure both front legs of the game animal 100. However, as shown in FIG. 2, there may be two ankle cuffs 544 such that each front leg of the game animal 100 may be secured in a separate ankle cuff 544.

An additional embodiment of a game fastener 50 may be a game securing harness, wherein the harness may be configured to bind any portion of the game animal's body. For example, the harness may be configured to secure the hind quarters of a game animal.

There may be a plurality of game fasteners 50. For example, in one embodiment (shown in FIG. 1), there may be two game fasteners 50 attached to the second end 44 of the two separate extenders 40, wherein both extenders 40 may be secured to the stick body 20. For example, as shown in FIG. 1, there may be two antler clasps 50a concurrently attached to the stick body 20. As such, more that one animal 100 may be secured to the same stick body 20 by using more than one game fastener 50. For example, a hunter may secure three rabbits to the same stick body 20 using three game fasteners 50.

In addition to having more than one configuration of game fastener 50, the game fasteners 50 may be interchangeable such that they are configured to removably attach to the stick body 20. Thus, there may be a first game fastener that is of a first configuration, a second game fastener that is of a second configuration, and so on. The user may select which to attach to the stick body 20. Hence, a user may choose to attach a first configuration of game fastener 50 on one hunting trip and another configuration for the next trip. The user may decide to attach both a first game fastener 50 that is of a first configuration, such as a large game securing harness 50b, and a second game fastener that is of a second configuration, such as a small game securing harness, to the stick body 20. The different configurations of game fasteners, combined with their interchangeability, allow the user to select the most appropriate fastener for the type of game animal 100 that may be secured.

FIG. 3 depicts a hunter's harness 70 that may be attached to the stick body 20. The hunter's harness 70 may be configured to be worn by a person, thereby freeing the person's hands during the transport of a game animal 100. The hunter's harness 70 may have padded shoulder straps 702 that clip in front of the chest of the user. The hunter's harness 70 may have an adjustable rope 704 that extends from the back of the harness and allows the user to adjust the length as desired. The rope may connect to a joint 706. At least two draglines 708 may also extend from the joint. Each dragline may have a harness pin 710 configured to attach the hunter's harness 70 to the stick body 20. Once the hunter's harness is connected to the stick body 20, a hunter may ambulate to drag the game animal 100 and may have his hands free.

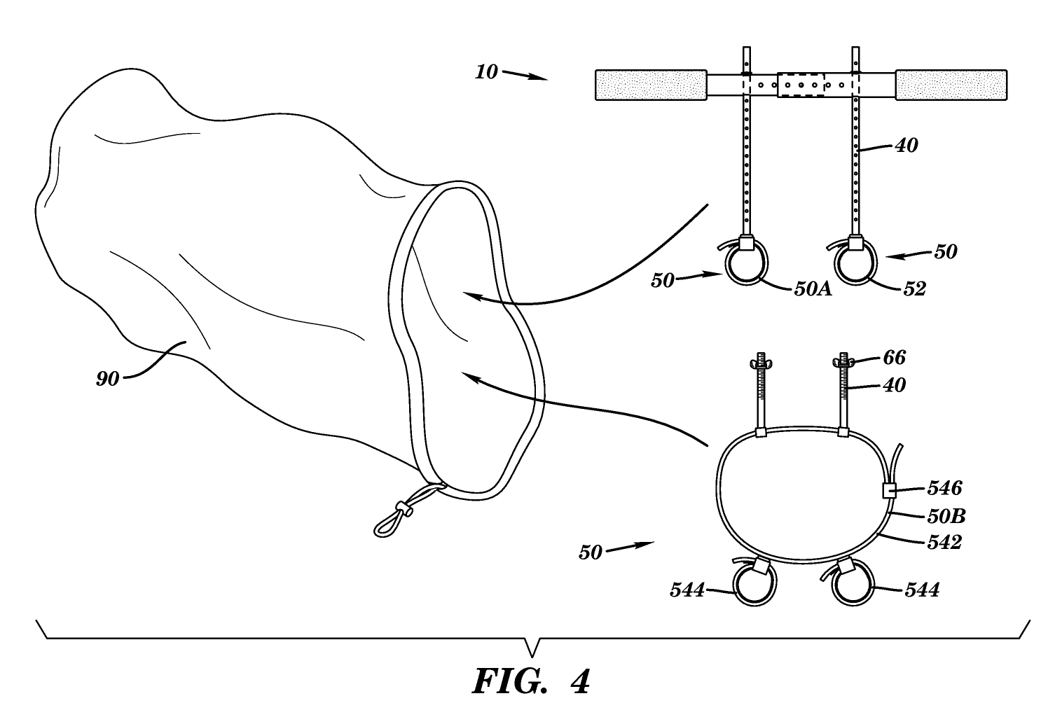

FIG. 4 depicts an embodiment of an adjustable game transporting device 10 of the present invention insertable within in a carry sack 90. The stick body 20 and accessories 40, 50a 50b,70 etc., fit inside the carrying sack 90 for ease of storage and transport of the device.

It should be understood that game fasteners 50 (e.g. 50a, 50b), and game fastener configurations may releasably attach to the stick body 20 via releasable and adjustable extenders 40. The extenders 40 may be integral to the game fasteners 50 or releasably connected to the game fasteners 50 (e.g. 50a, 50b). The extender 40 may extend from the stick body 20 by a length that is customizable to fit the game animal 100 being secured. Once attached to the stick body 20, the extender 40 and, thus, the game fastener 50, may be released and reattached in the same receiving aperture on the stick body 20 or another receiving aperture on the stick body 20. Thus, the operable position of the extender 40 and game fastener 50 may be customized to the size of the game animal 100 being secured. Furthermore, the game fasteners 50 (e.g. 50a, 50b) may be interchangeable, which may allow a user to select the best game fastener 50 for the particular game animal 100 being secured. As shown in FIG. 5, once the game animal 100 is fastened to at least one of the game fasteners 50 and the extender 40 is connected to the stick body 20, the user may use the stick body 20 to drag, or otherwise transport a game animal 100.

While particular embodiments of the present invention have been described herein for purposes of illustration, many modifications and changes will become apparent to those skilled in the art. Accordingly, the following claims are intended to encompass all such modifications and changes as fall within the true spirit and scope of this invention.

I claim:

1. An adjustable game transporting device comprising:
a stick body;
at least one releasable extender having a first end and a second end, wherein the first end is adjustably attached to said stick body such that the extender protrudes from said stick body a modifiable distance; and
at least one game fastener, wherein said game fastener is adjustable to secure the game animal, and wherein said game fastener is operatively attached to the second end of the releasable extender.

2. The device of claim 1, further comprising:
a plurality of releasable extenders; and
a plurality of game fasteners, such that there is a game fastener attached to each releasable extender.

3. The device of claim 2, wherein said plurality of game fasteners are interchangeable, and wherein a first game fastener of said plurality of game fasteners is of a first configuration and a second game fastener of said game fasteners is of a second configuration.

4. The device of claim 1, wherein said stick body is adjustable lengthwise to fit the size of the game being secured.

5. The device of claim 1, wherein said stick body is telescoping.

6. The device of claim 1, wherein said stick body is collapsible and further comprises:
a first section having a plurality of apertures;
a second section having at least one aperture, wherein said first section slides inside said second section such that said stick body is collapsible, and wherein at least one aperture from the plurality of apertures of said first section may be aligned with the aperture on said second section; and
a retainer pin configured to fit through at least one aperture in said first section and one aperture in said second section to connect said first section to said second section.

7. The device of claim 1, wherein said stick body is a hollow cylindrical baton having an adjustable stick body length further comprising:
a first section having a plurality of apertures;
a second section configured to slide inside said first section; and
at least one spring loaded pin affixed to said second section, wherein the spring loaded pin is operably positionable within an aperture of said first section to stabilize said first section and said second section.

8. The device of claim 1, wherein said stick body comprises a first section and a second section, wherein said first section is pivotally connected to said second section.

9. The device of claim 1, further comprising:
at least two handles on opposing ends of the stick body, wherein said handles include surface features configured to enhance gripping.

10. The device of claim 1, wherein said stick body further comprises a plurality of longitudinally aligned apertures and a plurality of receiving apertures located perpendicularly to the longitudinally aligned apertures, wherein said extender is insertable through at least a portion of the receiving aperture, and wherein the extender includes a plurality of holes alignable with at least one of the plurality of longitudinally aligned apertures, and wherein the device further comprises:
a holding pin configured to fit through an aperture of said stick body and a hole of said extender to secure said extender to said stick body such that said extender protrudes from said stick body a customizable distance corresponding to the size of the game animal and distance selection of the user.

11. The device of claim 1, wherein said stick body further comprises a plurality of apertures, wherein said releasable extender fits through at least one of a plurality of apertures, and wherein the device further comprises:
a means for releasably securing said releasable extender to said stick body.

12. The device of claim 1, wherein said game fastener is an antler clasp comprising straps selected from the group consisting of fabric straps, leather straps, rubber straps, rope, or chain.

13. The device of claim 1, wherein said game fastener is a game harness, comprising straps for securing the game animal, wherein said straps are composed of a material selected from the group consisting of leather, rubber, rope, chain, or fabric.

14. The device of claim 1, wherein said releasable extender further comprises a swivel head, and wherein said swivel head operatively connects said releasable extender to said game fastener.

15. The device of claim 1, further comprising:
a hunter's harness, wherein said hunter's harness attaches to the stick body, and wherein the hunter's harness is configured to be worn by a person.

16. The device of claim 15, further comprising:
harness pins configured to attach said hunter's harness to said stick body.

17. The device of claim 1, further comprising:
a carrying sack, wherein said stick body fits inside the carrying sack for ease of storage and transport of the device.

18. A game transporting device comprising:
a stick body;
at least two handles attached to said stick body; and
a plurality of interchangeable game fasteners, wherein said plurality of interchangeable game fasteners are configured to removably attach to said stick body, wherein a first game fastener of said plurality of game fasteners is of a first configuration and a second game fastener of said game fasteners is of a second configuration, and wherein at least one of said plurality of game fasteners is attached to said stick body.

19. The device of claim 18, wherein at least one of said plurality of game fasteners is an antler clasp constructed of one or more materials selected from the group consisting of leather, rubber, microfiber, plastic, nylon, metal, fabric, or any combination of said materials.

20. The device of claim 18, wherein at least one of said plurality of game fasteners is an adjustable antler clasp, configured to adjust to fit any size of animal's antlers to which the antler clasp is attached.

21. The device of claim 18, wherein at least one of said plurality of game fasteners is a game securing harness comprising a collar strap that may be adjusted to fit the neck of a game animal, and wherein at least two ankle cuffs configured to secure the feet, legs, or ankles of the game animal are attachable to the collar strap.

22. The device of claim 18 further comprising:
at least one extender having a first end and a second end, wherein the first end is removably and adjustably attached to said stick body such that said extender protrudes from said stick body a modifiable distance, and wherein the second end of said extender operatively attaches to at least one of said plurality of game fasteners.

23. The device of claim 22, wherein at least two extenders are attachable to the first game fastener of said plurality of game fasteners, and wherein said first game fastener is a game securing harness having a collar strap and ankle cuffs attached to the collar strap.

24. The device of claim 22, wherein the extender comprises at least one swivel head, wherein said swivel head connects the second end of said extender to at least one of said plurality of game fasteners such that the position of the at least one of said plurality of game fasteners is rotatable.

25. The device of claim 24, wherein there are a plurality of extenders, and wherein at least two of said plurality of game fasteners are attached to the second end of at least two of the extenders, and wherein the at least two of said plurality of game fasteners are adjustable antler clasps.

26. The device of claim 18, wherein said stick body has an adjustable length.

27. A device for transporting game comprising:
a handle;
at least two interchangeable game fasteners, wherein a first game fastener of said plurality of game fasteners is of a first configuration and a second game fastener of said game fasteners is of a second configuration; and
at least one game fastener extender configured to releasably attach to the interchangeable game fasteners, wherein said extender includes a game fastener end and a connecting end, and wherein said extender further includes means for removably securing said connecting end of the game fastener extender to the handle.

28. A method of transporting game comprising:
providing a bar having an adjustable length and at least two handles on opposing ends of the bar;
providing an extender configured to be removably secured to the bar such that the extender extends from the bar by a length that is customizable to fit a game animal;
providing a plurality of interchangeable game fasteners that may be attached to the extender;
fastening the game animal to at least one of the plurality of game fasteners;
connecting the extender to the bar; and
pulling the bar to thereby drag the game animal.

29. The method of claim 28, further comprising:
providing a hunter's harness that may be worn by a person, wherein said hunter's harness secures to the bar;
securing said hunter's harness to the bar;
wearing said hunter's harness attached to the bar; and
ambulating to drag the game animal.

30. The method of claim 28, wherein a first game fastener of said plurality of interchangeable game fasteners is an adjustable antler clasp, and wherein a second game fastener of said plurality of interchangeable game fasteners is a game securing harness.

31. The method of claim 30, wherein said game securing harness further comprises a collar strap and ankle cuffs, wherein said ankle cuffs are attached to the collar strap.
